(19) United States
(12) Patent Application Publication
(10) Pub. No.: US 2026/0059008 A1
(43) Pub. Date: Feb. 26, 2026

(54) UTILIZING FEATURE TAGS TO ENABLE FLEXIBLE CODEC NEGOTIATION

(71) Applicant: T-MOBILE INNOVATIONS LLC, Overland Park, KS (US)

(72) Inventor: Gunjan NIMBAVIKAR, Sammamish, WA (US)

(21) Appl. No.: 18/811,372

(22) Filed: Aug. 21, 2024

(51) Int. Cl. H04L 65/80; H04L 41/5009; H04L 65/1073; H04W 48/18

(52) U.S. Cl. CPC H04L 65/80; H04L 41/5009; H04L 65/1073; H04W 48/18

(57) ABSTRACT

Systems and methods for selecting one or more codecs are provided. A network may receive a message from a UE. The message may include one or more feature tags. The one or more feature tags may indicate an access network connection type between the UE and an access network and/or may indicate a key performance indicator (KPI) of the access network. Based on the feature tag, the network selects one or more codecs. The network communicates a response message to the UE. The response message includes the one or more codecs selected based on the feature tag.

### SUMMARY

The present disclosure is directed to systems and methods of selecting one or more codecs for a UE, substantially as shown and/or described in connection with at least one of the Figures, and as set forth more completely in the claims.

According to various aspects of the technology, systems and methods of selecting one or more codecs is provided. Subscribers of mobile communication networks communicate with one another, with data, and with services via various media sessions, however, the codecs selected for use during these sessions may be unsuitable for the particular access network and/or the particular conditions of the access network, as selection of codecs is typically based on the preference of the user equipment (UE). Thus a method for providing a codec aware registration network (CARN) (e.g., an IP multimedia subsystem (IMS) network) with one or more feature tags associated with the performance of an access network and/or a type of connection the UE has with the access network enables a more flexible codec selection and negotiation process.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device in which implementations of the present disclosure may be employed;

FIG. 2 illustrates a diagram of an exemplary environment in which implementations of the present disclosure may be employed;

FIG. 3 depicts a flow diagram of an exemplary method for selecting one or more codecs in which implementations of the present disclosure may be employed; and

FIG. 4 depicts a flow diagram of an exemplary method for selecting one or more codecs in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, subscribers of mobile communication networks communicate with one another via various media sessions, such as a voice call session or a real-time video call session. Before a subscriber will participate in a given media session, the user equipment (UE) associated with the subscriber will register with a codec aware registration network (CARN) (e.g., an IMS network). During this process, the CARN receives the UE's capabilities and preferences (e.g., from a home subscriber server (HSS), from the UE). For example, the UE may notify the CARN of compatible codecs, which compress and decompress media for transmission and playback during a media session. Some codecs may provide high quality media sessions, but require a significant amount of network resources be available in the network, and other codecs may require much less network resources but provide an overall lower quality media session.

Conventionally, when a UE is registering with the CARN, the CARN will evaluate the compatible codecs of the UE and may order the codecs in a prioritization order. Rules defining this prioritization process often defer to the codec that enables the highest quality media sessions, the UE's default codecs set by a UE manufacturer, and/or the UE's preference. However, these default rules fail to consider situations where a lower resource-consuming (e.g., low-bandwidth) codec would be preferred over higher quality session-enabling (e.g., high resource-consuming) codecs. For example, non-terrestrial networks (e.g., a satellite network) are often unsuitable for traditional voice sessions using high resource-consuming codecs. In this example, a UE connected to a non-terrestrial network may be compatible with or prefer a high resource-consuming codec, but the non-terrestrial network's available resources would not support a consistent, high-quality voice session. For example, the resulting voice session may provide high quality audio for a short period followed by a period of unwanted silence due to lack of bandwidth of the non-terrestrial network to transmit and receive audio. Thus, systems and methods enabling the tailoring of codec selection and prioritization based on the performance of the access network the UE is connected on to and/or the type of access network connection the UE has (e.g., to a non-terrestrial network) are valuable.

In contrast to conventional solutions, the present disclosure is directed to providing the CARN with one or more feature tags associated with the performance of the access network and/or a type of connection the UE has with the access network, enabling a more flexible codec negotiation. For example, the one or more feature tags may reflect that the UE is connected to a non-terrestrial network, and as a result, the IMS network may prioritize low resource-consuming codecs over high resource-consuming codecs. In another example, the one or more feature tags may indicate that the access network to which the UE is connected is experiencing congestion, and as a result, the IMS network may prioritize lower resource-consuming codecs over higher resource-consuming codecs. By providing one or more feature tags indicating performance of the access network and/or a type of connection the UE has with the access network, codec negotiation is more flexible and overall network performance is improved.

Accordingly, a first aspect of the present disclosure is directed to a method for selecting one or more codecs during registration. The method comprises receiving, at a network, a register message from a UE, wherein the register message comprises a feature tag indicating one or more key performance indicators (KPIs) of a connection between the UE and an access network exceeding a pre-determined threshold. The method further comprises selecting, based on the feature tag, the one or more codecs supported by the UE. The method further comprises communicating a response message to the UE, wherein the response message includes the one or more codecs selected based on the feature tag.

Another aspect of the present disclosure is directed to a method for selecting one or more codecs. The method comprises receiving, at a network, a message from a UE, wherein the message comprises a feature tag indicating an access network connection type of the UE. The method further comprises selecting, based on the feature tag, the one or more codecs supported by the UE. The method further comprises communicating a response message to the UE, wherein the response message includes the one or more codecs selected based on the feature tag.

Another aspect of the present disclosure is directed to a system for selecting one or more codecs. The system comprises one or more computer processing components configured to perform operations. The operations comprise receiving one or more feature tags from a UE, the one or more feature tags indicating at least one of: an access network connection type of the UE or one or more key performance indicators (KPIs) of a connection between an access network and the UE. The operations further comprise selecting, based on the one or more feature tags, the one or more codecs supported by the UE.

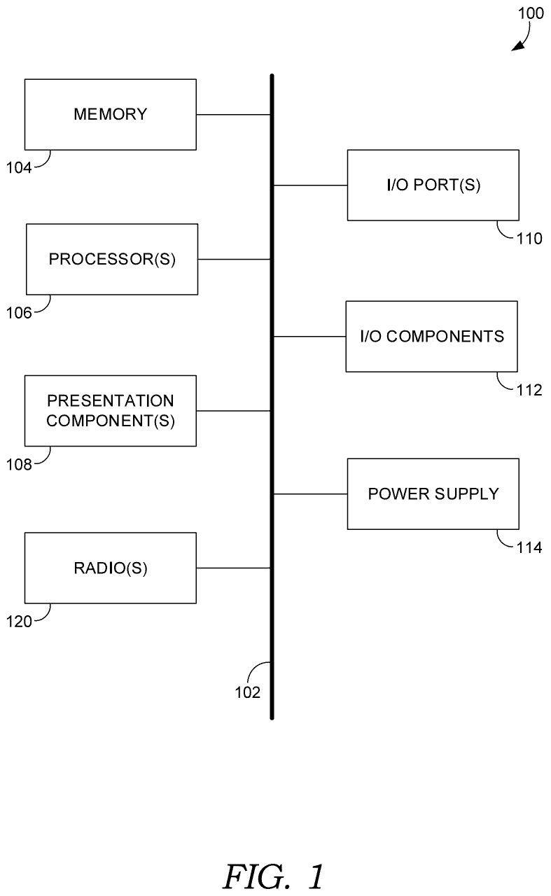

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device. ”Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitter to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

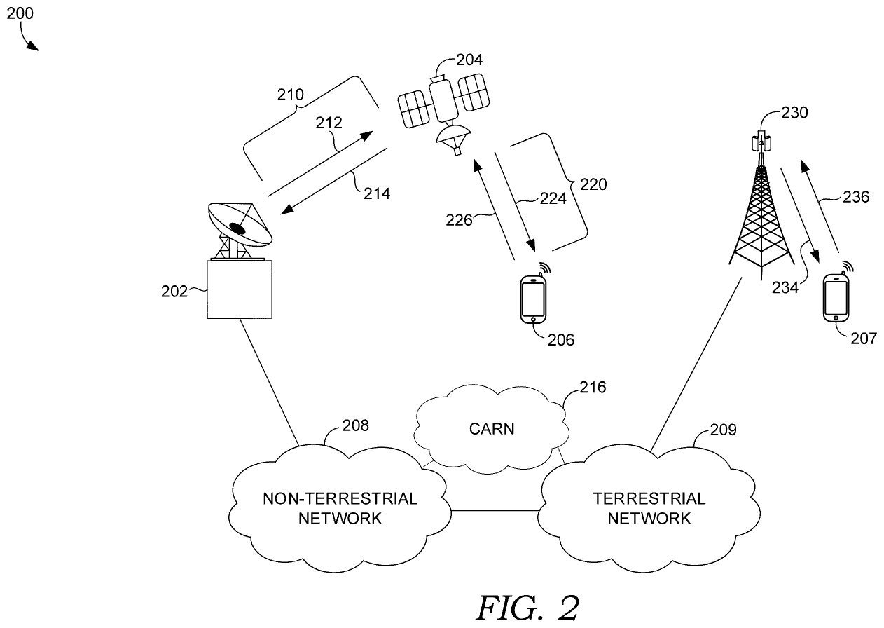

Turning now to FIG. 2, an exemplary network environment is illustrated in which some implementations of the present disclosure may be employed. Such a network environment is illustrated and designated generally as network environment 200. At a high level the network environment 200 may comprise a gateway 202, a non-terrestrial node 204 of a non-terrestrial radio access network (RAN) 208 (i.e., non-terrestrial network 208), one or more UEs (e.g., a first UE 206 and/or a second UE 207), a terrestrial base station 230 of a terrestrial RAN 209 (i.e., terrestrial network 209), and a codec aware registration network (CARN) 216. Though the composition of network environment 200 illustrates some objects in the singular, it should be understood that more than one of each component is expressly conceived as being within the bounds of the present disclosure; for example, the network environment 200 may comprise multiple gateways, multiple non-terrestrial nodes that communicate with a single gateway, multiple terrestrial base stations, and the like. Although FIG. 2 shows the non-terrestrial network 208 and the terrestrial network 209, it is expressly contemplated that other access network types may be present in the network environment 200. For example, the first UE 206 could access data and/or services via a public Wi-Fi connection, a mobile hotspot, a fixed line connection, and the like.

The network environment 200 includes one or more UEs, such as the first UE 206 and/or the second UE 207. In aspects, the first UE 206 and/or the second UE 207 are non-terrestrial network compatible UEs. Though the first UE 206 and a second UE 207 are illustrated as cellular phones, a UE suitable for implementations with the present disclosure may be any computing device having any one or more aspects described with respect to FIG. 1.

The network environment 200 may include a gateway 202 communicatively connected to the non-terrestrial network 208 and the non-terrestrial node 204. The gateway 202 may be connected to the non-terrestrial network 208 via one or more wireless or wired connections and is connected to the non-terrestrial node 204 via a feeder link 210. The gateway 202 may take the form of a device or a system of components configured to communicate with the first UE 206 via the non-terrestrial node 204 and to provide an interface between the non-terrestrial network 208 and the non-terrestrial node 204. Generally, the gateway 202 utilizes one or more antennas to transmit signals to the non-terrestrial node 204 via a forward uplink 212 and to receive signals from the non-terrestrial node 204 via a return downlink 214. The gateway 202 may communicate with a plurality of non-terrestrial nodes, including the non-terrestrial node 204.

The network environment 200 may include one or more non-terrestrial nodes, represented by non-terrestrial node 204. The non-terrestrial node 204 may take various forms (e.g., satellites, drones, aircrafts, high altitude platforms, and the like). The non-terrestrial node 204 may be generally configured to relay communications between the gateway 202 and one or more UEs, such as the first UE 206. The non-terrestrial node 204 may communicate with the gateway 202 using the feeder link 210 and may communicate with the first UE 206 using a user link 220. The user link 220 comprises a forward downlink 224 used to communicate signals from the non-terrestrial node 204 to the first UE 206 and a return uplink 226 used to communicate signals from the first UE 206 to the non-terrestrial node 204. The non-terrestrial node 204 may communicate with the first UE 206 using any wireless telecommunication protocol desired by a network operator, including but not limited to 3G, 4G, 5G, 6G, 802.11x and the like. Though a single forward downlink 224 and a single return uplink 226 are illustrated, the first UE 206 may utilize multiple downlinks and/or multiple uplinks to communicate with the non-terrestrial node 204, using any one or more frequencies as desired by a network operator.

The network environment 200 may include one or more non-terrestrial networks, represented by the non-terrestrial network 208. The non-terrestrial network 208 comprises any one or more public or private networks. In some aspects, the non-terrestrial network 208 may be configured as a satellite network connecting to a plurality of gateways, such as the gateway 202. A UE, such as the first UE 206 may communicate with the non-terrestrial network 208 via one or more non-terrestrial nodes, such as the non-terrestrial node 204.

The network environment 200 may include one or more terrestrial base stations, represented by terrestrial base station 230. The terrestrial base station 230 may be generally configured to relay communications between the terrestrial network 209 and one or more UEs, such as the second UE 207. The terrestrial base station 230 may communicate signals to the second UE 207 using a terrestrial downlink 234 and may receive signals from the second UE 207 using a terrestrial uplink 236. The terrestrial base station 230 may communicate with the second UE 207 using any wireless telecommunication protocol desired by a network operator, including but not limited to 3G, 4G, 5G, 6G, 802.11x and the like. Though a single terrestrial downlink 234 and a single terrestrial uplink 236 are illustrated, the second UE 207 may utilize multiple downlinks and/or multiple uplinks to communicate with the terrestrial base station 230, using any one or more frequencies as desired by a mobile network operator.

The network environment 200 may include one or more terrestrial networks, represented by the terrestrial network 209. The terrestrial network 209 may comprise any one or more public or private networks. In some aspects, the terrestrial network 209 may comprise a cellular telecommunications network (e.g., a 4G, 5G, 6G core network), a data network, and/or a publicly switched telephony network (PSTN). A UE, such as the second UE 207, may communicate with the terrestrial network 209 via one or more terrestrial base stations, such as the terrestrial base station 230.

The network environment 200 includes the CARN 216. In some aspects, the CARN 216 is an IP multimedia subsystem (IMS) network. The CARN 216 is generally responsible for session registration and setup, such as establishing a voice call session. The first UE 206 and/or the second UE 207 may register with the CARN when establishing such a session. The CARN 216 may be integrated with one or more access networks (e.g., the non-terrestrial network 208 and/or the terrestrial network 209). In some aspects, one or more of the access networks are integrated with the CARN 216, and in other aspects, access networks may have their own CARN.

As described above, when a UE (e.g., the first UE 206 and/or the second UE 207) is registering with the CARN 216 (e.g., an IMS network), the CARN 216 may receive and evaluate the compatible codecs of the UE and order the codecs in a prioritization order. Rules defining this prioritization process often default to the codec that enables the highest quality media sessions or to codecs selected by and/or prioritized by the UE manufacturer. However, these rules fail to consider situations where a lower resource-consuming (e.g., low-bandwidth) codec would be preferred over higher quality session-enabling (e.g., high resource-consuming) codecs. For example, UEs connected to specific types of access networks, (e.g., non-terrestrial networks) and engaging in traditional voice sessions using high resource-consuming codecs may experience reduced performance compared to a UE connected to a terrestrial network (e.g., the terrestrial network 209).

A UE (e.g., the first UE 206 and/or the second UE 207) may communicate a message to the CARN 216. The message may communicate the UE's capabilities, including the UE's supported codecs. The message may communicate the UE's preferences and/or default codec selections. For example, the UE may list its supported codecs in a particular order signaling a particular prioritization order (e.g., highest priority listed first). In some aspects, the message is a register message. In such aspects, the register message may be configured according to session initiation protocol (SIP). In other aspects, the message takes other forms (e.g., session establishment request, capabilities exchange answer) and/or is configured according to other protocols (e.g., diameter, GTP). The message from the UE (e.g., the first UE 206 and/or the second UE 207) includes one or more feature tags.

Relevant to the present disclosure, the CARN 216 may receive one or more feature tags from the UE (e.g., the first UE 206 and/or the second UE 207). Feature tags are generally configured as a label used to specify or identify particular functionalities, attributes, and/or capabilities associated with the UE. The one or more feature tags may indicate an access network connection type of the UE, one or more key performance indicators (KPIs) of a connection between an access network and the UE, or both. In some aspects, the one or more feature tags may be located in one or more headers of the message (e.g., a contact header) from the UE. In other aspects, the one or more feature tags may be located in a payload or a footer of the message from the UE. Based on the one or more feature tags, the CARN 216 may select one or more codecs supported by the UE. The CARN 216 may then communicate one or more response messages to the UE instructing the UE to utilize the one or more codecs selected based on the one or more feature tags. Once the CARN 216 selects the one or more codecs, the UE (e.g., the first UE 206 and/or the second UE 207) may use the one or more codecs to establish a session. In some aspects, the session is a call session with another UE (e.g., voice session, video session). In other aspects, the session is a streaming session, a rich communication services (RCS) session, a push to talk (PTT) session, and the like.

The one or more feature tags may indicate a type of access network connection between the UE (e.g., the first UE 206 and/or the second UE 207) and an access network. The type of access network connection may comprise the specific type of access network the UE is connected to and/or it may specify particular features of the access network connection of the UE. The particular type of access network connection may indicate whether a high resource-consuming codec or a low resource-consuming codec should be selected, for example. In some aspects, the one or more feature tags indicate the UE is connected to a non-terrestrial network (e.g., the non-terrestrial network 208). In other aspects, the one or more feature tags indicate the UE is connected to other types of access networks, such as a public Wi-Fi network, a mobile hotspot, a terrestrial network (e.g., the terrestrial network 209), a low-bandwidth fixed line connection, and the like. In aspects, the one or more feature tags may indicate features of the access network connection of the UE. For example, the one or more feature tags may indicate the UE has a cell edge connection to a terrestrial network (e.g., the terrestrial network 209), that the UE is connected to a mobile hotspot that has 4 or more devices, and the like.

The one or more feature tags may indicate one or more KPIs of a connection between the UE (e.g., the first UE 206 and/or the second UE 207) and may include that the access network exceeding one or more pre-determined thresholds. As used herein, “exceeds” includes surpassing the pre-determined threshold or falling below the pre-determined threshold. The particular pre-determined threshold value is determined based on the particular KPI. For example, the one or more feature tags may indicate a signal to interference noise ratio (SINR) exceeding a predetermined SINR threshold (e.g., the SINR falls below 0, 1, 3, or 5 dB) and/or a reference signal receive quality (RSRQ) exceeding a predetermined RSRQ threshold (e.g., the RSRQ falls below −15, −18, or −20 dB). The one or more feature tags may indicate a resource utilization metric exceeds a pre-determined resource threshold, such as an allocated number of resource blocks of the UE exceeding a pre-determined threshold. The one or more feature tags may indicate other KPIs exceed the applicable pre-determined threshold, such as throughput parameters (e.g., average downlink throughput), data latency (e.g., round-trip time (RTT), packet delay, packet loss), received signal received power (RSRP), received signal strength indicator (RSSI), and the like.

Based on the one or more feature tags, the CARN 216 may select one or more codecs supported by the UE (e.g., the first UE 206 and/or the second UE 207). The CARN 216 may include one or more rules used to interpret the one or more feature tags provided by the UE, which may be selected and/or modified by a network operator. For example, where the one or more feature tags indicate the access network connection type is a non-terrestrial connection (e.g., the first UE 206 connects to the non-terrestrial network 208), the CARN 216 may be configured to select one or more low resource-consuming codecs, such as a low-bandwidth codec, a low bit-rate codec, low-latency codec, and the like. In aspects, the CARN 216 may weigh both the one or more KPIs and the type of access network connection of the UE to select the one or more codecs. For example, the one or more feature tags may indicate the access network type is a mobile hotspot, and that there is only one device connected to the mobile hotspot. In this example, the CARN 216 may elect one or more higher resource-consuming codecs than if there had been four devices connected to the mobile hotspot.

Codecs may be classified in a number of ways, on relative scales (e.g., compared to each other in the same context), and in one or more contexts. As used above, codecs may be classified as low or lower resource-consuming and high or higher resource-consuming on a relative scale. For example, in the context of bandwidth, some codecs may have lower bandwidth demands than others, and some codecs may have higher bandwidth demands than others, on a relative scale. In another context, such as bit-rates, some codecs operate at higher bit-rates, and some codecs operate at lower bit-rates, on a relative scale. In the context of efficiency, some codecs are more efficient (e.g., higher compression ratios, lower computer processing power, lower memory usage) at encoding and decoding data and thus use less bandwidth than a less efficient codec operating at a similar bit-rate. Codecs may also be classified based on their quality produced weighed against network resources. For example, a more error-resistant codec may provide more stable quality when network resources are low as compared to a less error-resistant codec that may provide an overall higher quality, but less stable quality when network resources are low.

The CARN 216 may communicate the one or more codecs selected in one or more response messages. In some aspects, the one or more response messages are configured to SIP (e.g., SIP 183 message, 200 OK message). In some aspects, the CARN 216 may prioritize the one or more codecs selected. In such aspects, the CARN 216 may order the codecs in the order of most preferable to least preferable, or from least preferable to most preferable. For example, the CARN 216 may prioritize the one or more codecs from lowest bit-rate to higher bit-rates, from most to least efficient, from lowest error to highest error, on the relative scale, as described above. The one or more response messages may include instructions to the UE (e.g., the first UE 206 and/or the second UE 207) to present the one or more codecs (or the one or more prioritized codecs) to another entity (e.g., another UE, an application server, a network function) when setting up the session. Based on the one or more codecs presented, the UE and the other entity may negotiate for a compatible codec to be used in the session.

The UE (e.g., the first UE 206 and/or the second UE 207) may provide one or more updated feature tags. In aspects, the UE provides the one or more updated feature tags to the CARN when the original registration expires, which may be specified in the one or more response messages. In some aspects, when the UE provides the one or more updated feature tags, the one or more updated feature tags may indicate a change in access network connection type, a change in a value of the one or more KPIs, and/or a change in the one or more KPIs communicated to the CARN.

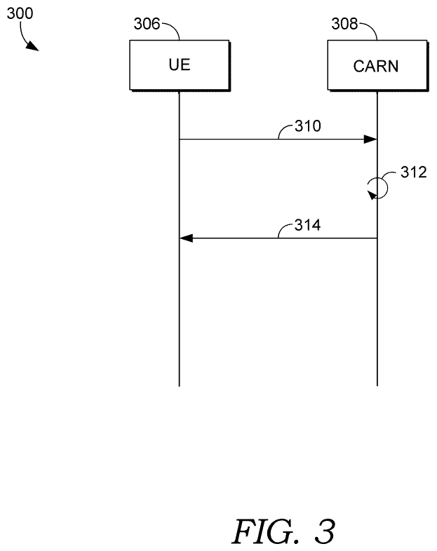

Turning now to FIG. 3, a call flow diagram is illustrated in accordance with one or more aspects of the present disclosure. A call flow 300 may be said to exist between one or more network components discussed in greater detail herein and is not meant to exhaustively show every interaction that would be necessary to practice the present disclosure, so as to not obscure the present disclosure, but is instead meant to illustrate one or more potential interactions between network components. The call flow 300 may be relevantly said to include a UE 306 (e.g., the first UE 206 and/or the second UE 207 of FIG. 2) and a CARN 308 (e.g., the CARN 216 of FIG. 2). The CARN 308 may comprise one or more network functions (e.g., one or more call session control functions (CSCFs), an HSS, an application server).

At a first step 310, the UE 306 communicates a message to the CARN 308. In some aspects, the message is a register message (e.g., SIP REGISTER message). The message includes the one or more feature tags, as described above with respect to FIG. 2. At the first step 310, the CARN 308 receives the message from the UE 306. At a second step 312, the CARN 308 selects one or more codecs, based on the one or more feature tags provided by the UE 306. The CARN 308 may evaluate the codecs supported by the UE 306 in one or more contexts, using one or more rules, and select the one or more codecs, as described with respect to FIG. 2. At a third step 314, the CARN 308 communicates a response message to the UE 306 including the one or more selected codecs, as described with respect to FIG. 2.

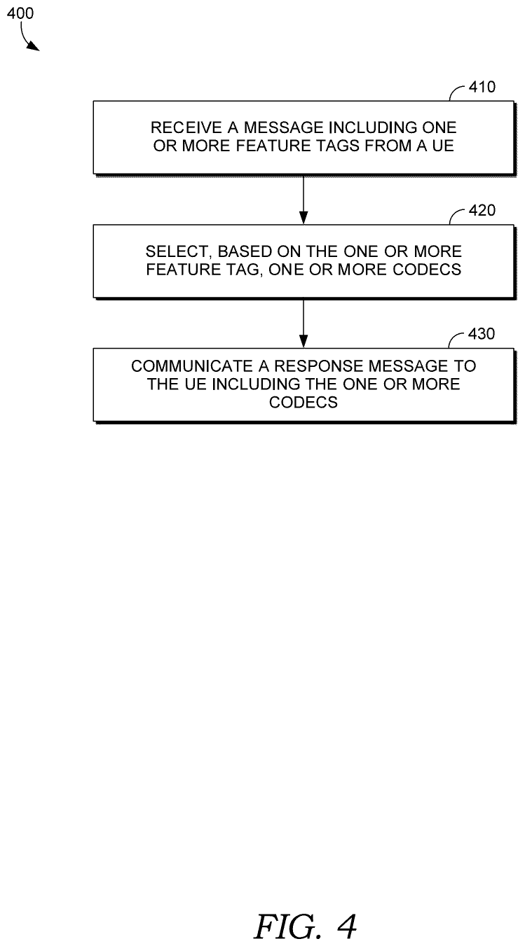

Turning now to FIG. 4, a flow chart representing a method 400 for selecting one or more codecs during registration is provided. The method 400 may be incorporated into a system having one or more of the components and/or features described with respect to FIGS. 2 and 3. At a first step 410, a CARN (e.g., the CARN 216 of FIG. 2, the CARN 308 of FIG. 3) (e.g., one or more network functions comprising the CARN), receives a message comprising one or more feature tags from a UE (e.g., the first UE 206 and/or the second UE 207 of FIG. 2, the UE 306 of FIG. 3), as described with respect to FIGS. 2 and 3. At a second step 420, the CARN selects, based on the one or more feature tags, one or more codecs, as described with respect to FIGS. 2 and 3. At a third step 430, the CARN communicates a response message to the UE including the one or more codecs selected based on the one or more feature tags, as described with respect to FIGS. 2 and 3. In aspects, the one or more codecs may be prioritized and/or the response message may include instructions to the UE.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for selecting one or more codecs during registration, the method comprising:
receiving, at a network, a register message from a UE, wherein the register message comprises a feature tag indicating one or more key performance indicators (KPIs) of a connection between the UE and an access network exceeding a pre-determined threshold;
selecting, based on the feature tag, the one or more codecs supported by the UE; and
communicating a response message to the UE, wherein the response message includes the one or more codecs selected based on the feature tag.

2. The method of claim 1, wherein the network is an IMS network.

3. The method of claim 1, wherein the one or more KPIs comprise a received signal strength indicator (RSSI).

4. The method of claim 1, wherein the one or more KPIs comprise a reference signal received quality (RSRQ).

5. The method of claim 1, wherein the one or more KPIs comprise a packet loss measure.

6. The method of claim 1, wherein the one or more KPIs comprise a data throughput measure.

7. The method of claim 1, wherein the one or more KPIs comprise a signal to noise ratio (SNR).

8. The method of claim 1, wherein, based on the feature tag, the network prioritizes the one or more codecs from lowest bit rate to highest bit rate.

9. The method of claim 8, further comprising:
based on one or more updated KPIs exceeding the pre-determined threshold, communicating, by the UE, an update register message to the network, wherein the update register message includes an updated feature tag.

10. A method for selecting one or more codecs, the method comprising:
receiving, at a network, a message from a UE, wherein the message comprises a feature tag indicating an access network connection type of the UE;
selecting, based on the feature tag, the one or more codecs supported by the UE; and
communicating a response message to the UE, wherein the response message includes the one or more codecs selected based on the feature tag.

11. The method of claim 10, wherein the feature tag is located in a contact header of the message from the UE.

12. The method of claim 10, wherein the feature tag indicates the access network connection type of the UE is a non-terrestrial network connection.

13. The method of claim 10, wherein based on the feature tag, the network prioritizes the one or more codecs from lowest bit rate to highest bit rate.

14. The method of claim 10, wherein the access network connection type of the UE is a cell edge connection.

15. The method of claim 10, wherein the access network connection type of the UE is a mobile hotspot network connection.

16. The method of claim 10, wherein the access network connection type of the UE is a public Wi-Fi network connection.

17. The method of claim 10, wherein the feature tag indicates the access network connection type is a 5G terrestrial connection, and wherein a codec having a highest bit rate of the one or more codecs is selected.

18. The method of claim 10, wherein the feature tag indicates the access network connection type is a non-terrestrial connection, and a codec having a lowest bit rate of the one or more codecs is prioritized by the network.

19. The method of claim 18, wherein the codec having the lowest bit rate of the one or more codecs is configured to provide push to talk.

20. A system for selecting one or more codecs, the system comprising:
one or more computer processing components configured to perform operations comprising:
receive one or more feature tags from a UE, the one or more feature tags indicating at least one of: an access network connection type of the UE or one or more key performance indicators (KPIs) of a connection between an access network and the UE; and
select, based on the one or more feature tags, the one or more codecs supported by the UE.
